(19) United States
(12) Patent Application Publication
(10) Pub. No.: US 2018/0040391 A1
(43) Pub. Date: Feb. 8, 2018

(54) GAS-INSULATED MEDIUM-OR HIGH-VOLTAGE ELECTRICAL APPARATUS INCLUDING HEPTAFLUOROISOBUTYRONITRILE AND TETRAFLUOROMETHANE

(71) Applicant: General Electric Technology GmbH, Baden (CH)

(72) Inventors: Yannick Kieffel, Saint-Jean-de-Bournay (FR); Jean-Marc Willieme, La Mulatiere (FR)

(21) Appl. No.: 15/550,599

(22) PCT Filed: Feb. 12, 2016
(86) PCT No.: PCT/EP2016/053079

§ 371 Date: Aug. 11, 2017

(30) Foreign Application Priority Data
Feb. 13, 2015 (FR) 1551216

(51) Int. Cl. H01B 3/56; H02B 13/055; H01H 33/22

(52) U.S. Cl. CPC H01B 3/56; H01H 33/22; H02B 13/055; H01H 2033/566

(57) ABSTRACT

The present invention relates to medium- or high-voltage equipment comprising a leaktight enclosure in which there are located electrical components and a gas mixture for providing electrical insulation and/or for extinguishing electric arcs that are likely to occur in the enclosure, the gas mixture comprising heptafluoroisobutyronitrile and tetrafluoromethane. Electrical components covered in solid dielectric layers of varying thickness are located inside the leaktight enclosure of the equipment of the invention.

### TECHNICAL FIELD

The invention relates to the field of electrical insulation and electric arc extinction in medium- or high-voltage equipment.

More particularly, the present invention relates to the use of a gas mixture comprising heptafluoroisobutyronitrile and tetrafluoromethane as a gas for electrical insulation and/or for electric arc extinction in medium- or high-voltage equipment.

More particularly, the present invention relates to the use of insulation having a low environmental impact based on a gaseous medium comprising heptafluoroisobutyronitrile and tetrafluoromethane as a gas for electrical insulation and/or for electric arc extinction in medium- or high-voltage equipment.

This insulation based on such a gas mixture may optionally be combined with solid insulation of low dielectric permittivity applied in layers of small or large thickness on the conductive parts subjected to an electric field that is greater than the breakdown field of the system without solid insulation. Since the thickness of the insulating layer is a function of the electric field utilization factor, η, defined as the ratio of the mean electric field (U/d) divided by the maximum electric field Emax (η=U/(Emax*d)), the layer is thick for utilization factors close to 0.3, while it is thin for utilization factors approaching 0.9.

It also relates to medium- or high-voltage equipment in which electric arc extinction is performed by a gaseous medium comprising heptafluoroisobutyronitrile and tetrafluoromethane, and electrical insulation is provided by the same gas in combination with solid insulation of low dielectric permittivity applied in a layer of small or large thickness on the conductive parts subjected to an electric field that is greater than the breakdown field of the system without solid insulation. This equipment may in particular be an electrical transformer such as a power or measurement transformer, a gas-insulated transmission line (GIL) for transporting or distributing electricity, a set of busbars, or even electrical connector/disconnector (also called switchgear), such as a circuit breaker, a switch, a unit combining a switch with fuses, a disconnector, a grounding switch, or a contactor.

### STATE OF THE PRIOR ART

In medium- or high-voltage substation equipment, electrical insulation and, if necessary, electric arc extinction are typically performed by a gas that is confined to the inside of said equipment.

Currently, sulfur hexafluoride (SF₆) is the gas most frequently used in this type of equipment. That gas presents dielectric strength that is relatively high, good thermal conductivity, and low dielectric losses. It is chemically inert, non-toxic for humans and animals and, after being dissociated by an electric arc, it recombines quickly and almost completely. In addition, it is non-flammable and its price is still moderate.

However, SF₆ has the main drawback of presenting a global warming potential (GWP) of 23500, (relative to CO₂ over 100 years) according to the latest Intergovernmental Panel on Climate Change (IPCC) report in 2013 and remains in the atmosphere for a time period of 3200 years, and this places it among gases that are strong greenhouse gases. SF₆ was therefore included in the Kyoto protocol (1997) in the list of gases for which emissions need to be limited.

The best way to limit SF₆ emissions consists in limiting the use of said gas, and this has led manufacturers to look for alternatives to SF₆.

However, “simple” gases such as air or nitrogen, which do not have a negative impact on the environment, present dielectric strengths that are much lower than that of SF₆. Because of that, the use of said “simple” gases for electrical insulation and/or electric arc extinction in substation equipment would require drastically increasing the volume and/or the filling pressure of said equipment, which goes against efforts that have been made over the past few decades to develop equipment that is compact, safe for workers, and less and less bulky.

Mixtures of SF₆ and nitrogen are used in order to limit the impact of SF₆ on the environment. The addition of SF₆ at 10% to 20% by volume makes it possible to significantly improve the dielectric strength of nitrogen. Nevertheless, as a result of the high GWP of SF₆, the GWP of those mixtures remains very high.

Such mixtures should therefore not be considered to be gases having low environmental impact.

The same applies for mixtures described in the European patent application having publication number 0 131 922, [1], and comprising about 60 to 99.5 molar percent SF₆ and about 0.5 to 40 molar percent of a saturated fluorocarbon, and selected in particular from C₂F₅CN, CBrClF₂, and c-C₄F₈.

Perfluorocarbons (CₙF₂ₙ₊₂ and c-C₄F₈) generally present advantageous dielectric strength properties but have GWPs typically in a range going from 5000 to 10,000 (6500 for CF₄, 7000 for C₃F₈ and C₄F₁₀, 8700 for c-C₄F₈, and 9200 for C₂F₆).

It should be noted that CF₄ has already been used in a mixture with SF₆ for applications at very low temperatures. In fact, the CF₄ presents arc-control properties that are close to those of SF₆, and is less sensitive at low temperatures, but its dielectric strength is not as good as that of SF₆. When using those SF₆—CF₄ mixtures, the overall performance of the mixture was thus limited because of the reduction in its dielectric properties due to the CF₄.

U.S. Pat. No. 4,547,316, [2], aims to provide an insulating gas mixture for electric devices that also presents considerable insulating properties and moderate toxicity for humans and animals, compared with C₂F₅CN. Thus, the proposed gas mixture comprises C₂F₅CN and an alkyl nitrite more particularly selected from the group consisting of methyl nitrite, ethyl nitrite, propyl nitrite, butyl nitrite, and amyl nitrite. In addition, such a mixture may include SF₆. However, little information is provided regarding the insulating properties of that mixture.

International application WO 2008/073790, [3], describes numerous other dielectric gases that are for use in the field of electrical insulation and of electric arc extinction in medium- or high-voltage equipment.

There exist other alternatives that are promising from a GWP and electrical characteristics point of view, such as trifluoroiodomethane (CF₃I). CF₃I presents dielectric strength that is greater than that of SF₆ and this applies both to uniform fields and non-uniform fields, for a GWP that is less than 5 and a time period spent in the atmosphere of 0.005 years. Unfortunately, in addition to the fact that CF₃I is expensive, it has an average occupational exposure limit (OEL) lying in the range 3 to 4 parts per million (ppm) and is classified among carcinogenic, mutagenic, and reprotoxic (CMR) category 3 substances, which is unacceptable for use on an industrial scale.

International application WO 2012/080246, [4], describes the use of one (or more) fluoroketone(s) in a mixture with air as electrical insulation and/or electric arc extinction means having low environmental impact. Because of the high boiling points for the fluids proposed, i.e. 49° C. for fluoroketone C6 and 23° C. for fluoroketone C5, those fluids are found in the liquid state at the usual minimum pressures and service temperatures for medium- and high-voltage equipment, thus obliging the inventors to add systems for vaporizing the liquid phase or for heating the outside of the equipment so as to maintain the temperature of the equipment above the liquefaction temperature for fluoroketones. That outside vaporizing system and in particular heating system complicates the design of the equipment, reduces its reliability in the event of its power supply being cut off, and gives rise to additional electricity consumption that may reach one hundred megawatt hours (MWh) over the lifetime of the equipment, and that goes against the aim of reducing the environmental impact of the equipment and in particular, reducing carbon emissions. From a point of view of reliability at low temperature, in the event of the power supply being cut off at low temperature, the gaseous phase of the fluoroketone(s) liquefies, thereby considerably lowering the concentration of fluoroketone(s) in the gas mixture and thus reducing the insulating power of the equipment, which equipment is then incapable of withstanding the voltage in the event of the power supply being restored.

It has also been proposed to use hybrid insulation systems associating gas insulation, e.g. dry air, nitrogen, or CO₂, with solid insulation. As described in the European patent application having publication number 1 724 802, [5], that solid insulation consists, for example, in covering those live parts that present steep electric gradients with a resin of the epoxy resin type or the like, thereby making it possible to reduce the respective fields to which the live parts are subjected. International application WO 2014/037566, [6], proposes such a hybrid insulation system in which the gas insulation consists of heptafluoroisobutyronitrile in a dilution gas.

However, the resulting insulation is not equivalent to the insulation provided by SF₆, and the use of those hybrid systems requires the volume of equipment to be increased relative to the volume made possible with SF₆ insulation.

For controlling electric arcs without SF₆, various solutions exist: extinguishing in oil; extinguishing in ambient air; extinguishing using a vacuum circuit breaker. However, equipment that extinguishes in oil presents the major drawback of exploding in the event of failing to extinguish or of internal failure. Equipment in which electric arcs are extinguished in ambient air is generally of large dimensions, costly, and sensitive to the environment (moisture, pollution), whereas equipment, in particular of the switch-disconnector type, having a vacuum circuit breaker is very expensive and, as a result, is not very common on the market for voltages higher than 72.5 kilovolts (kV).

In view of the above, the inventors have therefore generally sought to find an alternative to SF₆, that has low environmental impact relative to identical SF₆ equipment, while ensuring that the characteristics of the equipment, from the point of view of its insulating and extinguishing abilities, are maintained close to those of SF₆, and without significantly increasing the size of the equipment or the pressure of the gas inside it.

In addition, the inventors have sought to maintain the operating temperature ranges of the equipment close to those of equivalent SF₆ equipment, and to do so without external heater means.

More specifically, the inventors have sought to find an insulation system comprising at least a gas or a mixture of gases that, while presenting electrical insulation or electric arc extinction properties that are sufficient for application in the field of high-voltage equipment and that are in particular comparable to SF₆ equipment, also has an impact on the environment that is low or zero.

They have also sought to provide an insulation system, and in particular the gas or mixture of gases included in said system, that is non-toxic for humans and the environment.

They have further sought to provide an insulation system, and in particular the gas or mixture of gases, having a manufacture or purchase cost that is compatible with use on an industrial scale.

They have further sought to provide medium- or high-voltage equipment based on said insulation system, and in particular the gas or mixture of gases having size and pressure that are close to those of equivalent equipment insulated with SF₆ and that does not present liquefaction at the minimum utilization temperature without the addition of an external heat source.

### SUMMARY OF THE INVENTION

These objects and others are achieved by the invention, which proposes the use of a particular gas mixture, optionally combined with a solid insulation system, making it possible to obtain medium- or high-voltage equipment having low environmental impact and improved breaking ability.

Thus, the insulation system implemented in the context of the present invention is based on a gaseous medium comprising heptafluoroisobutyronitrile in a mixture with tetrafluoromethane for use as a gas for electrical insulation and/or for electric arc extinction in medium- or high-voltage equipment.

In general, the present invention provides medium- or high-voltage equipment including a leaktight enclosure in which there are located electrical components and a gas mixture for providing electrical insulation and/or for extinguishing electric arcs that are likely to occur in said enclosure, the gas mixture comprising heptafluoroisobutyronitrile and tetrafluoromethane.

In the equipment of the present invention, the gas insulation implements a gas mixture including heptafluoroisobutyronitrile and tetrafluoromethane.

Above and below, the terms “medium voltage” and “high voltage” are used in the conventionally accepted manner, i.e. the term “medium voltage” refers to a voltage that is greater than 1000 volts (V) for alternating current (AC) or greater than 1500 V for direct current (DC) but that does not exceed 52,000 V for AC or 75,000 V for DC, whereas the term “high voltage” refers to a voltage that is strictly greater than 52,000 V for AC and 75,000 V for DC.

Heptafluoroisobutyronitrile of formula (I): (CF₃)₂CFCN (I), hereafter written i-C₃F₇CN, corresponds to 2,3,3,3-tetrafluoro-2-trifluoromethyl propanenitrile, CAS number: 42532-60-5. This compound presents

(i) a boiling point of −4.7° C. at 1013 hectopascals (hPa) (boiling point measured in accordance with ASTM D1120-94 “Standard Test Method of Boiling Point of Engine Coolants”);

(ii) a molar mass of 195 g·mol⁻¹;

(iii) a GWP of 2210 (calculated over 100 years in accordance with the IPCC method, 2013); and

(iv) an ozone depletion potential (ODP) of 0.

Table I below gives the relative dielectric strength of heptafluoroisobutyronitrile having formula (I), as normalized relative to the gas that it is desired to replace, i.e. SF₆ and as compared to that of N₂, said dielectric strength being measured at atmospheric pressure, at a DC voltage, between two steel electrodes having a diameter of 2.54 centimeters (cm) and spaced apart by 0.1 cm.

TABLE I

| SF₆ | N₂ | C₃F₇CN |
|---|---|---|
| 1.0 | 0.35-0.4 | 2.6 |

The tetrafluoromethane (or carbon tetrafluoride) of formula CF₄ and CAS number: 75-73-0 presents:

(i′) a boiling point of −127.8° C. at 1013 hPa (boiling point measured in accordance with ASTM D1120-94);

(ii′) a molar mass of 88 g·mol⁻¹;

(iii′) a GWP of 6500 (calculated over 100 years in accordance with the IPCC method, 2013); and

(iv′) an ODP of 0.

Table II below gives the relative dielectric strength of tetrafluoromethane having formula CF₄, as normalized relative to the gas that it is desired to replace, i.e. SF₆, said dielectric strength being measured at atmospheric pressure, at a DC voltage, between two steel electrodes having a diameter of 2.54 cm and spaced apart by 0.1 cm.

TABLE II

| SF₆ | CF₄ |
|---|---|
| 1.0 | 0.4-0.5 |

Thus, the above-described heptafluoroisobutyronitrile and tetrafluoromethane that are neither toxic, nor corrosive, nor flammable, and that present a GWP that is significantly less than that of SF₆, are endowed with electrical insulation and electric arc extinction properties suitable for enabling them, possibly mixed with a dilution gas, to replace the SF₆ as a gas for electrical insulation and/or electric arc extinction in medium- or high-voltage equipment.

However, it should be noted that despite being lower than that of SF₆, the GWP of tetrafluoromethane is high. It is therefore appropriate to minimize the presence of this compound in the gas mixture and to determine its quantity as a function of the target GWP of the gas mixture.

Then, it should be noted that there is an unexpected synergy factor between the heptafluoroisobutyronitrile and the tetrafluoromethane in the gas mixtures according to the invention which makes it possible to improve the dielectric and extinguishing properties. The improvement thus obtained is greater than the sum of the weighted contributions of each of the constituents of these gas mixtures.

More particularly, the present invention provides gas insulation having low environmental impact combining a gas mixture having an environmental impact that is low (low GWP relative to SF₆), that is compatible with minimum utilization temperatures of the equipment, and that has dielectric, extinguishing and thermal dissipation properties that are better than those of conventional gases such as CO₂, air, or nitrogen.

In the context of the present invention, the heptafluoroisobutyronitrile and the tetrafluoromethane are present in the medium- or high-voltage equipment exclusively or almost exclusively in the gaseous state under all temperature conditions for which the gaseous medium is intended to be subjected to, once confined inside the equipment. To do this, the heptafluoroisobutyronitrile and the tetrafluoromethane should be present in the equipment at partial pressures that are selected as a function of the respective saturated vapor pressures presented by these compounds at the minimum utilization temperature of the equipment. The term “minimum utilization temperature” is used of equipment to refer to the lowest temperature at which said equipment is designed to be used.

Heptafluoroisobutyronitrile and tetrafluoromethane may thus be the only constituents of the gaseous medium confined in the medium- or high-voltage equipment.

However, in view of the generally recommended filling pressure levels for medium- and high-voltage equipment that are typically several bars and in view of, firstly, the liquefaction temperature of heptafluoroisobutyronitrile at normal atmospheric pressure (1 013.25 hPa) and, secondly the GWP of tetrafluoromethane, heptafluoroisobutyronitrile, and tetrafluoromethane are most often used diluted in at least one other gas in such a manner as to obtain the recommended filling pressure level for the equipment under consideration while guaranteeing that heptafluoroisobutyronitrile is maintained in the gaseous state over the entire range of utilization temperatures for said equipment.

According to the invention, when said other gas, known as a dilution gas or vector gas or buffer gas, is present it is selected from gases that meet the four following criteria:

(1) presenting a boiling temperature that is very low, less than the minimum utilization temperature of the equipment; said boiling temperature typically being equal to or less than −50° C. at standard pressure;

(2) presenting dielectric strength that is greater than or equal to that of carbon dioxide in test conditions that are identical to those used for measuring the dielectric strength of said carbon dioxide (i.e. same equipment, same geometrical configuration, same operating parameters, . . . );

(3) being non-toxic for humans and the environment; and

(4) presenting a GWP that is lower than that of the heptafluoroisobutyronitrile and tetrafluoromethane mixture so that diluting this mixture with the dilution gas also has the effect of lowering the environmental impact of the mixture, since the GWP of a gas mixture is a weighted average derived from the sum of the fractions by weight of each of the compounds in the mixture multiplied by its corresponding GWP.

The dilution gases usually used are GWP-neutral gases having a GWP that is very low, typically equal to or less than 500 and, more preferably, equal to or less than 10.

Gases that present this set of properties are for example air, and advantageously dry air (GWP of 0), nitrogen (GWP of 0), helium (GWP of 0), carbon dioxide (GWP of 1), oxygen (GWP of 0), and nitrous oxide (GWP of 310). Also, any one of these gases or mixtures thereof may be used as a dilution gas in the invention.

In the context of the present invention, heptafluoroisobutyronitrile is present in the equipment at a partial pressure that advantageously lies in the range 90% to 100% and, in particular, in the range 98% and 100% of the pressure corresponding, at the filling pressure of the equipment, to the saturated vapor pressure presented by heptafluoroisobutyronitrile at the minimum utilization temperature of the equipment. Thus, the dielectric properties of the gaseous medium both in a direct line and in tracking are the best possible, and come as close as possible to those of SF₆.

In other words, in order to have the maximum amount of heptafluoroisobutyronitrile at the minimum utilization temperature of the equipment of the present invention without generating a liquid phase, the composition of the gaseous medium is defined according to Raoult's law for the minimum utilization temperature of the equipment, or even for a temperature that is slightly higher than said minimum utilization temperature, in particular 3° C. higher. In particular, for a ternary mixture comprising heptafluoroisobutyronitrile (i-C₃F₇CN), tetrafluoromethane (CF₄) and dilution gas, the pressures of each of the components are therefore defined by the following equation:

$${P}_{total} = \frac{{P}_{i \text{-} C 3 F 7 CN} + {P}_{CF 4}}{\frac{{P}_{i \text{-} C 3 F 7 CN}}{{PVS}_{i \text{-} C 3 F 7 CN}} + \frac{{P}_{CF 4}}{{PVS}_{CF 4}}} + {P}_{dilution gas}$$

with PVS_{iC3F7CN}=saturated vapor pressure of heptapfluoroisobutyronitrile and PVS_{CF4}=saturated vapor pressure of tetrafluoromethane.

Advantageously, in the context of the present invention, the minimum utilization temperature Tₘᵢₙ is selected from 0° C., −5° C., −10° C., −15° C., −20° C., −25° C., −30° C., −35° C., −40° C., −45° C., and −50° C., and, in particular, selected from 0° C., −5° C., −10° C., −15° C., −20° C., −25° C., −30° C., −35° C., and −40° C.

In a particular implementation, the gas mixture implemented in the context of the present invention is a ternary mixture comprising or consisting of:
1 molar percent (mol %) to 20 mol % of i-C₃F₇CN;
1 mol % to 40 mol % of CF₄; and
40 mol % to 98 mol % of dilution gas.

A particular example of a gas mixture for use in the present invention comprises or consists of i-C₃F₇CN, CF₄, and CO₂. A more particular example of a gas mixture for use in the present invention comprises or consists of 1 mol % to 20 mol % of i-C₃F₇CN; of 1 mol % to 40 mol % of CF₄, and of 40 mol % to 98 mol % of CO₂.

In order to improve overall dielectric strength, in a hybrid insulation system, the gas mixture comprising heptafluoroisobutyronitrile and tetrafluoromethane may be used in combination with solid insulation, in particular of low dielectric permittivity, that is applied as insulating layers of varying thicknesses on those conductive parts that are subjected to a respective electric field that is greater than the breakdown field of the medium- or high-voltage equipment without the solid insulation.

In fact, the medium- or high-voltage equipment of the invention presents some electrical components that are not covered in a solid dielectric layer.

In other words, electrical components covered in a solid dielectric layer of varying thicknesses are located inside the leaktight enclosure of the medium- or high-voltage equipment of the present invention.

The dielectric/insulating layer used in the invention presents low relative permittivity. “Low relative permittivity” refers to relative permittivity that is less than or equal to 6. It should be recalled that the relative permittivity of a material, also known as its dielectric constant, and written Eᵣ, is a dimensionless quantity that may be defined by the formulas (IV) and (V) below:

∈ᵣ=∈/∈₀ (IV), with

∈=(e*C)/S and ∈₀=1/(36π*10⁹) (V)

in which:
∈ corresponds to the absolute permittivity of the material (expressed in farads per meter (F/m));
∈₀ corresponds to the permittivity of a vacuum (expressed in F/m);
C corresponds to the capacitance (expressed in farads (F)) of a plane capacitor comprising two parallel electrodes having placed between them a layer of material of permittivity that is to be determined, said layer representing a test piece;
e corresponds to the distance (expressed in meters (m)) between the two parallel electrodes of the plane capacitor, which in this instance corresponds to the thickness of the test piece; and
S corresponds to the area (expressed in square meters (m²)) of each electrode constituting the plane capacitor.

In the context of the present invention, the capacitance is determined as in IEC standard 60250-ed1.0, i.e. by using a capacitor comprising two circular electrodes of diameter lying in the range 50 mm to 54 mm, secured to the test piece constituted by the material, said electrodes being obtained by spraying a conductive paint with a guard device. The test piece presents dimensions of 100 mm×100 mm and a thickness of 3 mm. The distance between the electrodes of the capacitor that corresponds to the above-mentioned parameter e, is therefore 3 mm.

In addition, the capacitance is determined using an excitation level of 500 volts root mean square (Vrms), at a frequency of 50 hertz (Hz), at a temperature of 23° C., and at relative humidity of 50%. The above-mentioned voltage is applied for a duration of 1 minute (min).

“Insulating/dielectric layer of varying thickness” indicates in the context of the present invention that the dielectric material, as deposited or applied on the electrical components or conductive parts, presents thickness that varies as a function of the conductive part or conductive part portion on which it is deposited. The thickness of the layer does not vary while the equipment is in use but is determined during preparation of the elements constituting the equipment.

In the context of the invention, the insulating layer is applied as a layer of small or large thickness on the conductive parts subjected to an electric field that is greater than the breakdown field of the system without solid insulation.

More particularly, since the thickness of the insulating layer implemented in the context of the present invention is a function of the electric field utilization factor, η, defined as the ratio of the mean electric field (U/d) divided by the maximum electric field Emax (η=U/(Emax*d)), the layer is thick for utilization factors close to 0.3, i.e. lying in the range 0.2 to 0.4 and the layer is thin for utilization factors approaching 0.9, i.e. greater than 0.5, and in particular greater than 0.6.

In the context of the present invention, “thick layer” refers to a layer of thickness that is greater than 1 mm and less than 10 mm and “thin layer” refers to a layer of thickness that is less than 1 mm, advantageously less than 500 micrometers (μm), in particular lying in the range 60 μm to 100 μm.

The solid insulating layer implemented in the context of the present invention may comprise a single dielectric material or a plurality of different dielectric materials. In addition, the composition of the insulating layer, i.e. the nature of the dielectric material(s) that the layer comprises may differ as a function of the conductive part or portion of conductive part on which the solid insulating layer is deposited.

In particular, in the invention, the materials used for making the thick insulating layers present relative permittivities that are low, i.e. less than or equal to 6. In a particular embodiment of the invention, the dielectric permittivities of the insulating materials used for making the thick solid layers present relative permittivities of about 3 or less, i.e. relative permittivities less than or equal to 4, and in particular less than or equal to 3. By way of examples of materials suitable for use in making the thick solid dielectric layers in equipment of the invention, mention may be made of polytetrafluoroethylene, polyimide, polyethylene, polypropylene, polystyrene, polycarbonate, polymethyl methacrylate, polysulfone, polyetherimide, polyether ether ketone, parylene N™, Nuflon™, silicone, and epoxy resin.

As regards the materials used for making the thin layers, the materials selected in the context of the invention present relative permittivities of the order of 3, i.e. lying in the range 2 to 4 and in particular in the range 2.5 to 3.5. By way of example of materials suitable for use in making the thin solid dielectric layers in equipment of the invention, mention may be made of polytetrafluoroethylene, polyimide, polyethylene, polypropylene, polystyrene, polyamide, ethylene-monochlorotrifluoroethylene, parylene N™, Nuflon™, HALAR™, and HALAR C™.

In accordance with the invention, the equipment may be, firstly, a gas-insulated electrical transformer, e.g. a power transformer or a measurement transformer.

It may also be an overhead or buried gas-insulated line, or a set of busbars for transporting or distributing electricity.

There may also be an element for connection to the other equipment in the network, e.g. overhead lines or partition bushings.

Finally, the equipment may also be a connector/disconnector (also called switchgear) such as, for example, a circuit breaker, such as a circuit breaker of the “dead tank” type, a “puffer” or “self blast”-type circuit breaker, a puffer-type circuit breaker having double motion arcing contacts, a thermal-effect puffer-type circuit breaker having single motion arcing contacts, a thermal-effect puffer-type circuit breaker having partial movement of the contact pin, a switch, a disconnector, such as air-insulated switchgear (AIS) or gas-insulated switchgear (GIS), a unit combining a switch with fuses, a grounding switch, or a contactor.

The present invention also provides the use of a gas mixture comprising heptafluoroisobutyronitrile and tetrafluoromethane as a gas for electrical insulation and/or for electric arc extinction in medium- or high-voltage equipment, in which electrical components may further be covered with a solid insulating layer of varying thickness as defined above.

Other characteristics and advantages of the invention can be seen more clearly from the additional description below, given by way of illustrative and non-limiting example.

### DETAILED DESCRIPTION OF PARTICULAR EMBODIMENTS

The invention is based on the use of a particular gas mixture having a low environmental impact and improved breaking ability combining heptafluoroisobutyronitrile and tetrafluoromethane as defined above, with or without dilution gas.

In the present invention, the expressions “dilution gas”, “neutral gas”, or “buffer gas” are equivalent and may be used interchangeably.

Advantageously, heptafluoroisobutyronitrile and tetrafluoromethane are present in the equipment exclusively or almost exclusively in gaseous form over the entire range of utilization temperatures for said equipment. It is therefore advisable for the partial pressure of the heptafluoroisobutyronitrile in the equipment to be selected as a function of the saturated vapor pressure (PVS) presented by this compound at the lowest utilization temperature of said equipment.

However, since equipment is usually filled with gas at ambient temperature, the pressure to which reference is made in order to fill the equipment with heptafluoroisobutyronitrile is the pressure P_{Tfill} that corresponds, at the filling temperature, e.g. 20° C., to the PVS presented by said compound at the lowest utilization temperature Tₘᵢₙ of said equipment. This correspondence is given, for each compound, by the formula:

P_{Tfill}=PVS_{Tmin}×293)/Tₘᵢₙ

with Tₘᵢₙ expressed in kelvins.

By way of example, the Table II below gives the saturated vapor pressures, referenced PVS_{i-C3F7CN} and expressed in hectopascals, presented by heptafluoroisobutyronitrile at temperatures of 0° C., −5° C., −10° C., −15° C., −20° C., −25° C., −30° C., −35° C., and −40° C., as well as the pressures, referenced P and expressed in hectopascals, which correspond to those saturated vapor pressures raised to 20° C.

TABLE III
saturated vapor pressures of i-C₃F₇CN

| | PVS_{i-C3F7CN} | P_{i-C3F7CN} |
|---|---|---|
| Temperatures | (hPa) | (hPa) |
| 0° C. | 1177 | 1264 |
| −5° C. | 968 | 1058 |
| −10° C. | 788 | 877 |
| −15° C. | 634 | 720 |
| −20° C. | 504 | 583 |
| −25° C. | 395 | 466 |
| −30° C. | 305 | 368 |
| −35° C. | 232 | 286 |
| −40° C. | 173 | 218 |

Tetrafluoromethane, with a boiling point of the order of −128° C., is always in the gaseaous state at the usual maximum pressure and minimum temperatures for medium- and high-voltage equipment. As a result, the saturated vapor pressures are not given for this compound since they are never reached.

Thus, for example, equipment designed for being used at a minimum temperature of −30° C. will be filled, at the temperature of 20° C., with a partial pressure of heptafluoroisobutyronitrile that does not exceed 368 hPa at 20° C. if it is desired to maintain this compound in the gaseous state in said equipment over the entire range of utilization temperatures for said equipment.

Depending on the equipment, the recommended total filling pressure for filling with the gaseous medium varies. However, said pressure is typically of several bars, i.e. several hundreds of kilopascals (kPa).

Also, although in theory heptafluoroisobutyronitrile and tetrafluoromethane may represent the only components of the gaseous medium, they usually have a dilution gas (or vector gas or buffer gas) added thereto, making it possible to obtain the recommended level of filling pressure.

Preferably, the dilution gas is selected from gases presenting, firstly, a very low boiling temperature, less than or equal to the minimum utilization temperature of the equipment, and, secondly, a dielectric strength that is greater than or equal to that of carbon dioxide under test conditions (same equipment, same geometrical configuration, same operating parameters, . . . ) that are identical to those used in order to measure the dielectric strength of the carbon dioxide.

In addition, it is preferred for the dilution gas to be non-toxic and for it to present a GWP that is low, or zero, in such a manner that dilution of the tetrafluoromethane by said gas also has the effect of reducing the environmental impact of said compound since the GWP of a gaseous mixture is proportional to the partial pressures of each of its components.

Also, the dilution gas is preferably: carbon dioxide having a GWP that is equal to 1; nitrogen, oxygen, or air, advantageously dry air, having a GWP that is equal to 0; or mixtures thereof.

Since heptafluoroisobutyronitrile and tetrafluoromethane have dielectric strengths that are greater than those of the gases likely to be used as a dilution gas, it is desirable to optimize filling of the equipment with heptafluoroisobutyronitrile and tetrafluoromethane. The equipment should therefore be filled with heptafluoroisobutyronitrile at a partial pressure that advantageously lies in the range 95% to 100% and, more preferably in the range 98% to 100% of the pressure corresponding, at the filling temperature, to the saturated vapor pressure presented by the compound at the minimum utilization temperature of the equipment.

In other words, heptafluoroisobutyronitrile is preferably present in the gaseous medium at a molar percentage lying in the range 95 mol % to 100 mol % and, more preferably, in the range 98 mol % to 100 mol %, where the molar percentage M is given, for each compound, by the formula:

M=(P_{Tfill}/P_{medium})×100, in which:
P_{Tfill} represents the pressure that corresponds, at the filling temperature and for heptafluoroisobutyronitrile, to the saturated vapor pressure presented by said compound at the minimum utilization temperature of the equipment; and
P_{medium} represents the total pressure of the gaseous medium (i-C₃F₇CN+CF₄+dilution gas) at the filling temperature.

A first particular example of a ternary gas mixture for use in the invention at a minimum temperature of −30° C. consists of:
4.1 mol % of i-C₃F₇CN;
20 mol % of CF₄; and
75.9 mol % of CO₂.

Such a mixture makes it possible to obtain a reduction of the order of 90.2% of the carbon equivalent for pure SF₆ (Table V).

TABLE IV

| | | | | Mass |
|---|---|---|---|---|
| | Molar | | mol % | fraction |
| Gas | mass | GWP | (% P) | (w %) |
| i-C₃F₇CN | 195 | 2210 | 4.10% | 13.55% |
| CF₄ | 88 | 6500 | 20.00% | 29.84% |
| CO₂ | 44 | 1 | 75.90% | 56.61% |

GWP mixture = 2239
Reduction/SF₆ = 90.2%

A second particular example of a ternary gas mixture for use in the invention at a minimum temperature of −25° C. consists of:
6.3 mol % of i-C₃F₇CN;
20 mol % of CF₄; and
73.7 mol % of CO₂.

Such a mixture makes it possible to obtain a reduction of the order of 90.0% of the carbon equivalent for pure SF₆ (Table VI).

TABLE V

| | | | | Mass |
|---|---|---|---|---|
| | Molar | | mol % | fraction |
| Gas | mass | GWP | (% P) | (w %) |
| i-C₃F₇CN | 195 | 2210 | 6.30% | 19.71% |
| CF₄ | 88 | 6500 | 20.00% | 28.24% |
| CO₂ | 44 | 1 | 73.70% | 52.04% |

GWP mixture = 2272
Reduction/SF₆ = 90.0%

From a practical point of view, after creating a vacuum by means of an oil vacuum pump, commercial equipment at 5 bar (500 kPa) for use at −30° C. may be filled by means of a gas mixer making it possible to control the ratio between the pressures of the heptafluoroisobutyronitrile and of the tetrafluoromethane, and the pressure of the dilution gas, said ratio being kept constant and equal to 6.3 mol % for heptafluoroisobutyronitrile, and to 20 mol % for tetrafluoromethane throughout filling by using a precision mass flowmeter. The vacuum (0 kPa to 0.1 kPa) is preferably prepared beforehand inside the equipment.

In addition, it should be observed that future equipment will be fitted with molecular sieves of the anhydrous calcium sulfate (CaSO₄) type, which adsorb the humidity of the gas and therefore reduce the toxicity and the acidity of the gaseous medium after a partial discharge, as caused by potentially toxic molecules, typically HF.

In addition, at the end of its life or after circuit-breaking tests, the gaseous medium can be recovered by conventional recovery techniques using a compressor and a vacuum pump. The heptafluoroisobutyronitrile and the tetrafluoromethane may then be separated from the dilution gas by using a zeolite capable of trapping only the smaller-sized dilution gas; alternatively, it is possible to use a selective separation membrane that allows the dilution gas to escape and retains the heptafluoroisobutyronitrile and the tetrafluoromethane, since said heptafluoroisobutyronitrile and tetrafluoromethane have greater molar masses than the dilution gas. Naturally, any other option may be envisaged.

Thus, the present invention proposes gas mixtures having a low environmental impact with reduction factors of the CO₂ equivalent that are very substantial (of the order of 90%), that are compatible with the minimum utilization temperatures of the equipment, and that have dielectric properties that are improved relative to typical gases such as CO₂, air, or nitrogen, and close to those of pure SF₆ while improving its breaking abilities. This gaseous medium may advantageously replace the SF₆ currently used in equipment, with the design of the equipment being modified little or not at all: the same production lines can be used, while changing only the gaseous medium used for filling.

So as to obtain dielectric equivalence with SF₆, (reaching 100% of the strength of SF₆), without reducing its performance at low temperature or increasing the total amount of pressure, the gas mixture presented above is used in combination with solid insulation having low dielectric permittivity that is applied on those conductive parts that are subjected to respective electric fields that are greater than the breakdown field of the system without solid insulation.

The solid insulation implemented in the context of the present invention is in the form of a layer of thickness that varies for a given piece of equipment. The implemented insulating layer may present low thickness (thin or fine layer), or high thickness (thick layer).

Since the thickness of the insulating layer is a function of the electric field factor, η, defined as the ratio of the mean electric field (U/d) divided by the maximum electric field Emax (η=U/(Emax*d)), the layer is thick for utilization factors close to 0.3, and the layer is thin for utilization factors approaching 0.9.

This solution therefore makes it possible to reduce the maximum electric field on the gaseous phase and thus to increase the dielectric strength of the “mixed” total insulation that is made up in series of solid insulation and of gas insulation. This phenomenon of reducing the electric field acting on the gaseous phase is more pronounced when the dielectric permittivity of the solid layer is low.

### REFERENCES

[1] European patent application, in the name of Mitsubishi Denki Kabushiki Kaisha, published under number 0 131 922 on Jan. 23, 1985.
[2] U.S. Pat. No. 4,547,316, in the name of Mitsubishi Denki Kabushiki Kaisha, published on Oct. 15, 1985.
[3] International application WO 2008/073790, in the name of Honeywell International Inc., published on Jun. 19, 2008.
[4] International application WO 2012/080246, in the name of ABB Technology AG., published on Jun. 21, 2012.
[5] European patent application, in the name of Mitsubishi Denki Kabushiki Kaisha, published under number 1 724 802 on Nov. 22, 2006.
[6] International application WO 2014/037566, in the name of Alstom Technology Ltd, published on Mar. 13, 2014.

What is claimed is:

1. Medium- or high-voltage equipment comprising a leaktight enclosure in which there are located electrical components and a gas mixture for providing electrical insulation and/or for extinguishing electric arcs that are likely to occur in said enclosure, the gas mixture comprising heptafluoroisobutyronitrile and tetrafluoromethane.

2. Equipment according to claim 1, characterized in that said gas mixture further comprises a dilution gas.

3. Equipment according to claim 2, characterized in that said dilution gas is selected from carbon dioxide, nitrogen, oxygen, air, and mixtures thereof.

4. Equipment according to claim 1, characterized in that heptafluoroisobutyronitrile is present in said equipment at a partial pressure selected as a function of the saturated vapor pressure presented by heptafluoroisobutyronitrile at the minimum utilization temperature of said equipment.

5. Equipment according to claim 1, characterized in that heptafluoroisobutyronitrile is present in said equipment at a partial pressure that lies in the range 95% to 100% of the pressure corresponding, at the filling temperature of said equipment, to the saturated vapor pressure presented by heptafluoroisobutyronitrile at the minimum utilization temperature of the equipment.

6. Equipment according to claim 4, characterized in that said minimum utilization temperature of said equipment is selected from 0° C., −5° C., −10° C., −15° C., −20° C., −25° C., −30° C., −35° C., −40° C., −45° C., and −50° C. and, in particular, selected from 0° C., −5° C., −10° C., −15° C., −20° C., −25° C., −30° C., −35° C., and −40° C.

7. Equipment according to claim 1, characterized in that said gas mixture is a ternary mixture consisting of
1 mol % to 20 mol % of i-C₃F₇CN;
1 mol % to 40 mol % of CF₄; and
40 mol % to 98 mol % of dilution gas and in particular CO₂.

8. Equipment according to claim 1, characterized in that electrical components covered in solid dielectric layers of varying thicknesses are located inside said leaktight enclosure.

9. Equipment according to claim 8, characterized in that, the thickness of said solid dielectric layer is a function of the electric field utilization factor, η, defined as the ratio of the mean electric field (U/d) divided by the maximum electric field Emax (η=U/(Emax*d)), and said solid dielectric layer is a thick layer presenting a thickness that is greater than 1 mm and less than 10 mm for utilization factors lying in the range 0.2 to 0.4.

10. Equipment according to claim 9, characterized in that the material(s) selected for making said thick solid dielectric layer present(s) relative permittivity that is less than or equal to 6, in particular less than or equal to 4 and in particular less than or equal to 3.

11. Equipment according to claim 8, characterized in that the thickness of said solid dielectric layer is a function of the electric field utilization factor, η, defined as the ratio of the mean electric field (U/d) divided by the maximum electric field, Emax (η=U/(Emax*d)), and said solid dielectric layer is a thin layer presenting a thickness that is less than 1 mm, advantageously less than 500 μm, in particular lying in the range 60 μm to 100 μm for utilization factors greater than 0.5, and in particular greater than 0.6.

12. Equipment according to claim 11, characterized in that the material(s) selected for making said thin solid dielectric layer present(s) relative permittivity lying in the range 2 to 4 and in particular in the range 2.5 to 3.5.

13. Equipment according to claim 1, characterized in that said equipment is a gas-insulated electrical transformer, a gas-insulated line for transporting or distributing electricity, an element for connecting to other pieces of equipment in the network, or a connector/disconnector.

14. A use of a gas mixture comprising heptafluoroisobutyronitrile and tetrafluoromethane as a gas for electrical insulation and/or for electric arc extinction in medium- or high-voltage equipment, having electrical components that are possibly covered with a solid insulating layer of varying thickness.
